(19) United States
(12) Patent Application Publication
(10) Pub. No.: US 2009/0116359 A1
(43) Pub. Date: May 7, 2009

(54) OPTICAL SCANNING DEVICE

(75) Inventors: Bernardus Hendrikus Wilhelmus Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/909,099

(22) PCT Filed: Mar. 14, 2006
(86) PCT No.: PCT/IB2006/050799

§ 371 Date: Sep. 19, 2007

(30) Foreign Application Priority Data
Mar. 24, 2005 (EP) 05102367.9

(51) Int. Cl. G11B 3/74; G11B 7/00

(52) U.S. Cl. 369/94; 369/112.23; G9B/7

(57) ABSTRACT

An optical scanning device for scanning an information layer of a first optical record carrier having a first cover layer thickness and an information layer of a second optical record carrier having a second, different cover layer thickness. The device includes an objective lens system for converging a radiation beam on the information layers. The objective lens system includes a first lens element and a second lens element spaced apart along an optical axis. The objective lens system further includes a switchable optical element comprising a first fluid, and a chamber positioned between said first lens and said second lens. The objective lens system is switchable between a first configuration in which the first fluid occupies an optically active portion of the chamber such that the objective lens system has a first focal length for scanning the information layer of the first optical record carrier, and a second configuration in which the first fluid does not occupy the optically active portion of the chamber such that the objective lens system has a second, different focal length for scanning the information layer of the second optical record carrier. The objective lens system is arranged to satisfy the condition: Focal2−Focal1>0.9 (T2−T1)/N, where T1 is the first cover layer thickness, T2 is the second cover layer thickness, T2>T1, N is the refractive index of the second cover layer, Focal 1 is the first focal length, and Focal2 is the second focal length.

The present invention relates to an objective lens for use in an optical scanning device for scanning optical record carriers having different cover layer thicknesses, to an optical scanning device incorporating such an objective lens, and to a method of manufacturing such a scanning device. The present invention is particularly suitable for, but not limited to, providing a plastic compound objective lens for scanning two or more types of optical record carrier.

Data can be stored in the form of information layers of optical record carriers. A variety of types of optical record carrier exist, such as compact discs (CDs), convention digital versatile discs (DVDs) and so-called Blu-Ray discs.

Blu-Ray discs have recently been proposed, that utilise blue laser diodes that emit light at a significantly shorter wavelength than the red laser diodes used to read data from or write data to conventional DVDs. As the wavelength of the blue laser diode is shorter than that of more commonly used red laser diodes, the blue laser diode can form a smaller spot on the disc, and hence the information layer tracks of Blu-Ray discs can be more closely spaced than those conventional DVDs. Thus, Blu-Ray discs can have a greater storage capacity than conventional DVDs—typically at least a two fold increase in storage capacity can be obtained.

It is desirable for a single optical scanning device to be able to be capable of scanning (e.g. reading data from or writing data to) a number of optical record carriers of different formats. However, different record carrier formats and the associated scanning devices often require different characteristics. For example, CDs are designed to be scanned with a beam wavelength of about 785 nm, and with a numerical aperture of 0.45. DVDs are designed to be scanned at a beam wavelength in the region of 650 nm, whilst Blu-Ray discs are designed to be scanned at a wavelength around 405 nm. A numerical aperture of 0.6 is generally utilised for reading DVDs, whilst a numerical aperture of 0.65 is generally used for writing to DVDs.

Often, discs designed to be read at certain wavelengths are not readable at other wavelengths e.g. due to the wavelength sensitivity of the dye in the formation layer. Consequently, multi-format optical scanning devices (devices used to scan more than one type of optical record carrier) often contain one or more radiation sources, for providing the relevant radiation beams at the required wavelengths.

Different types of record carrier also differ in the thickness of their transparent substrate. The transparent substrate typically acts as a protective layer for the information layer (the data carrying layer) of the record carrier. As a result, the depth of the information layer from the entrance face of the record carrier (the cover layer thickness) varies from record carrier type to record carrier type. For example, a Blu-Ray disc may have a cover layer thickness of 0.1 mm, a DVD disc may have a cover layer thickness of 0.6 mm and a CD a cover layer thickness of 1.2 mm.

To reduce manufacturing cost, it is desirable to form the objective lens from plastic, rather than glass. Due to the lower refractive index of plastic, the objective lens is typically formed of two refractive elements i.e. as a compound lens. Such a two element lens generally has a lower free working distance than a corresponding single objective lens.

It is an aim of embodiments of the present invention to address one or more problems of the prior art, whether referred to herein or otherwise.

According to a first aspect of the present invention there is provided an optical scanning device for scanning an information layer of a first optical record carrier having a first cover layer thickness and an information layer of a second optical record carrier having a second, different cover layer thickness; the device comprising an objective lens system for converging a radiation beam on said information layers, the objective lens system comprising a first lens element and a second lens element spaced apart along an optical axis; the objective lens system further comprising a switchable optical element comprising a first fluid, and a chamber positioned between said first lens and said second lens; wherein the objective lens system is switchable between a first configuration in which the first fluid occupies an optically active portion of the chamber and a second configuration in which the first fluid does not occupy the optically active portion of the chamber, such that in one of said configurations the objective lens system has a first focal length for scanning the information layer of the first optical record carrier, and in the other configuration the objective lens system has a second, different focal length for scanning the information layer of the second optical record carrier, and the objective lens system is arranged to satisfy the condition: Focal2−Focal1>0.9 (T2−T1)/N, where T1 is the first cover layer thickness, T2 is the second cover layer thickness, T2>T1, N is the refractive index of the second cover layer, Focal1 is the first focal length, and Focal2 is the second focal length.

Thus, by utilising such a switchable optical element, the focal length of the objective lens is easily adjustable by movement of the fluid so as to maintain an appropriate free working distance between the outer surface of the optical record carrier being scanned and the adjacent surface of the objective lens system. By utilising such a switchable optical element, damage of the lens, by contacting a scanned record carrier, is prevented. In some instances, the free working distance may be relatively small e.g. if, in one or more of said configurations, the objective lens system is utilised to scan the information layer of an optical record carrier in the near field.

Preferably, the objective lens system is arranged to satisfy the condition: F2>F1 where F2 is the free working distance between the objective lens system in the second configuration and the second optical carrier, and F1 is the free working distance between the objective lens system of the first configuration and the first optical record carrier.

Preferably, at least one of said focal lengths is of sufficient magnitude to ensure that the free working distance between the objective lens system and the optical record carrier being scanned is greater than a predetermined minimum.

Preferably, each of said focal lengths is of sufficient magnitude to ensure that free working distance between the objective lens system and the optical record carrier being scanning is greater than a predetermined minimum.

Said minimum free working distance may be 50 μm.

Preferably, first fluid is an electrically susceptible fluid, the chamber being provided with an electrode configuration, wherein application of a voltage, from a voltage control system, to electrodes causes movement of the fluid, and wherein the electrode configuration comprises at least one first, central, electrode adjacent to the inner walls of the chamber at the position of the optically active portion, at least one second electrode adjacent to the inner walls of the chamber at positions outside the optically active portion, and a third electrode in contact with the electrically susceptible fluid such that the optical element will be in the first configuration when a voltage is applied between said first electrode and the third electrode, and in the second configuration when a voltage is applied between said second electrode and the third electrode.

The interior wall of the chamber may be coated with an insulating hydrophobic layer.

The chamber may further comprise one of a vapour of the first fluid, and a second fluid having an index of refraction different from that of the conductive fluid.

At least one chamber wall situated in the optically active portion may form a refractive lens surface.

At least one chamber surface situated in the optically active portion may form a diffractive grating structure.

The optical scanning device may be arranged for scanning the first information layer by means of a first radiation beam having a first wavelength, the second information layer by means of a second radiation beam having a second wavelength, and a third information layer of a third optical record carrier by means of a third radiation beam having a third wavelength, wherein said first, second and third wavelengths differ from each other, and wherein the diffractive grating structure comprises a series of steps of predetermined height to introduce a phase change that is in integral multiple of 2π for at least one of said wavelengths in at least one of said configurations.

Preferably, the change in focal length between the first configuration and the second configuration provides the required change in numerical aperture for scanning the respective optical record carrier.

According to a second aspect of the present invention there is provided an objective lens system for an optical scanning device, the optical scanning device being arranged to scan an information layer of a first optical record carrier having a first cover layer thickness and an information layer of a second optical record carrier having a second, different cover layer thickness, the objective lens system being suitable for converging a radiation beam on said information layers, the objective lens system comprising a first lens and a second lens spaced apart along an optical axis; the objective lens system further comprising a switchable optical element comprising a first fluid, and a chamber positioned between said first lens and said second lens; wherein the objective lens system is switchable between a first configuration in which the first fluid occupies an optically active portion of the chamber and a second configuration in which the first fluid does not occupy the optically active portion of the chamber, such that in one of said configurations the objective lens system has a first focal length for scanning the information layer of the first optical record carrier, and in the other configuration the objective lens system has a second, different focal length for scanning the information layer of the second optical record carrier, and the objective lens system is arranged to satisfy the condition: Focal2−Focal1>0.9 (T2−T1)/N, where T1 is the first cover layer thickness, T2 is the second cover layer thickness, T2>T1, N is the refractive index of the second cover layer, Focal1 is the first focal length, and Focal2 is the second focal length.

According to a third aspect of the present invention there is provided a method of manufacturing an optical scanning device for scanning an information layer of a first optical record carrier having a first cover layer thickness and an information layer of a second optical record carrier having a second, different cover layer thickness; the method comprising: providing an objective lens system for converging a radiation beam on said information layers, the objective lens system comprising a first lens element and a second lens element spaced apart along an optical axis; the objective lens system further comprising a switchable optical element comprising a first fluid, and a chamber positioned between said first lens and said second lens; wherein the objective lens system is switchable between a first configuration in which the first fluid occupies an optically active portion of the chamber and a second configuration in which the first fluid does not occupy the optically active portion of the chamber, such that in one of said configurations the objective lens system has a first focal length for scanning the information layer of the first optical record carrier, and in the other configuration the objective lens system has a second, different focal length for scanning the information layer of the second optical record carrier, and the objective lens system is arranged to satisfy the condition: Focal2−Focal1>0.9 (T2−T1)/N, where T1 is the first cover layer thickness, T2 is the second cover layer thickness, T2>T1, N is the refractive index of the second cover layer, Focal1 is the first focal length, and Focal2 is the second focal length.

Embodiments of the present invention will now be described, by way of example only, with reference to the accompanying figures, in which:

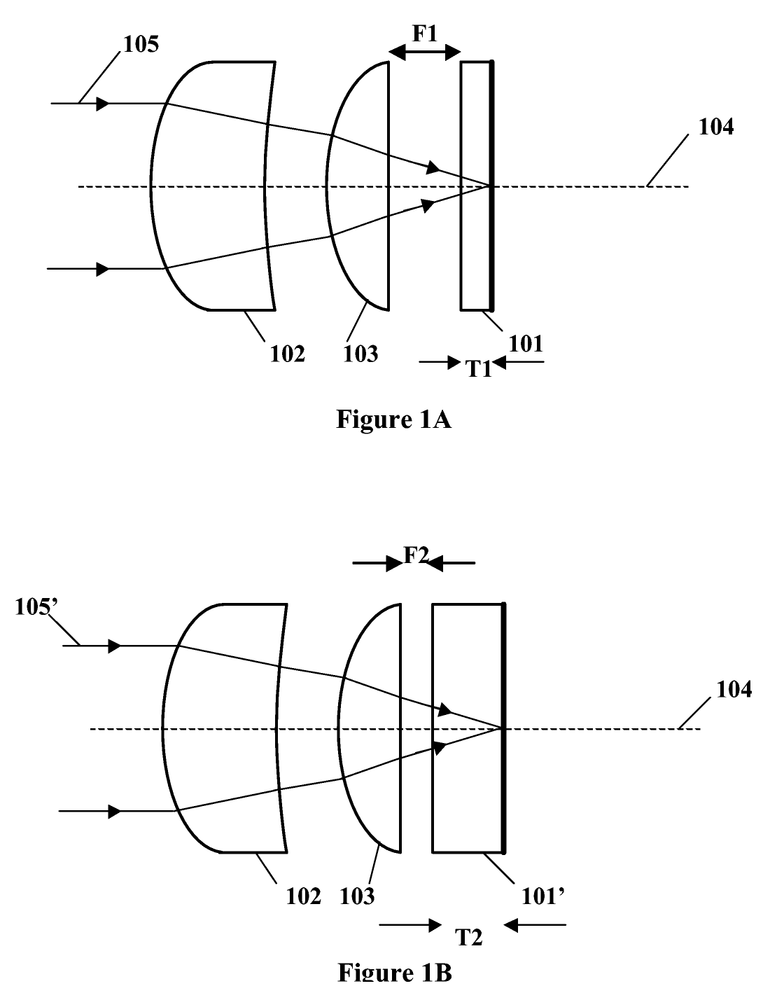

FIG. 1A and FIG. 1B are schematic cross-sectional diagrams of a conventional objective lens system scanning respectively a first optical record carrier, and a second optical record carrier having a larger cover layer thickness;

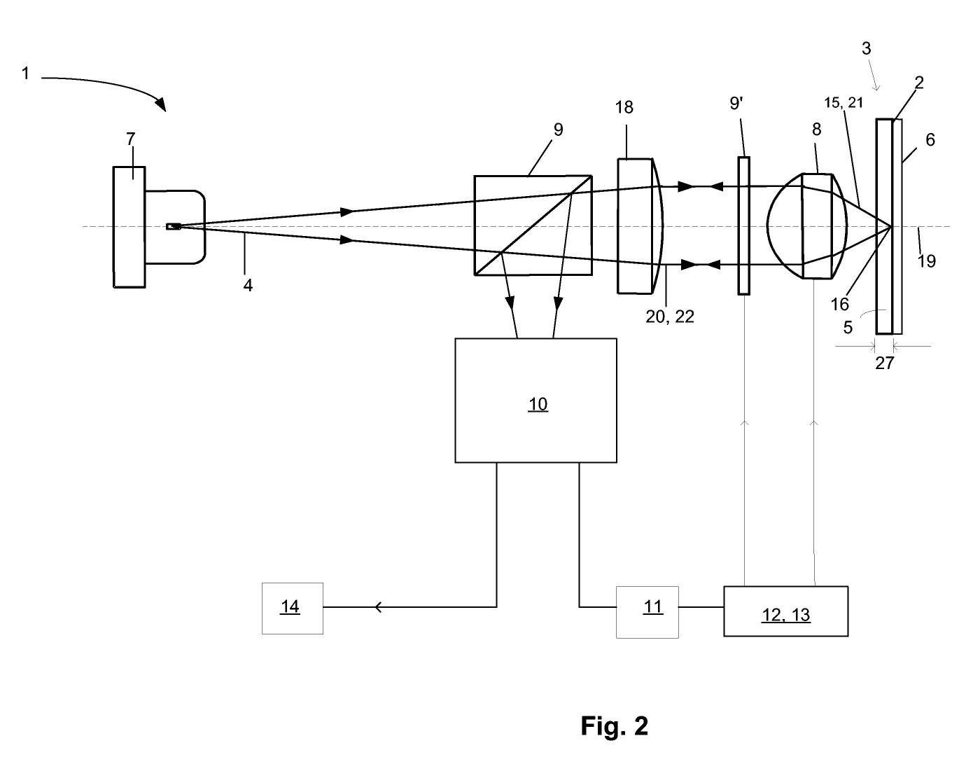

FIG. 2 is a schematic diagram of an optical scanning device in accordance with an embodiment of the present invention;

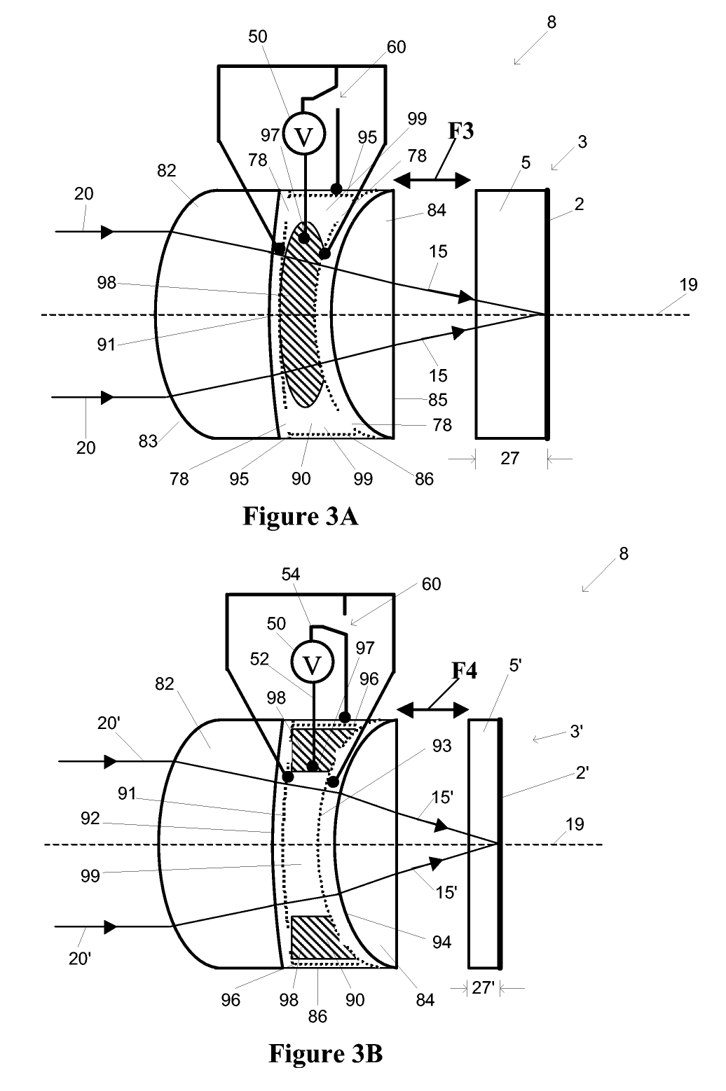

FIGS. 3A and 3B illustrate schematic cross sectional views of an objective lens system in accordance with an embodiment of the present invention, in a first configuration for scanning a disc having a first cover layer thickness and in a second configuration for scanning a disc having a second, larger cover layer thickness; and

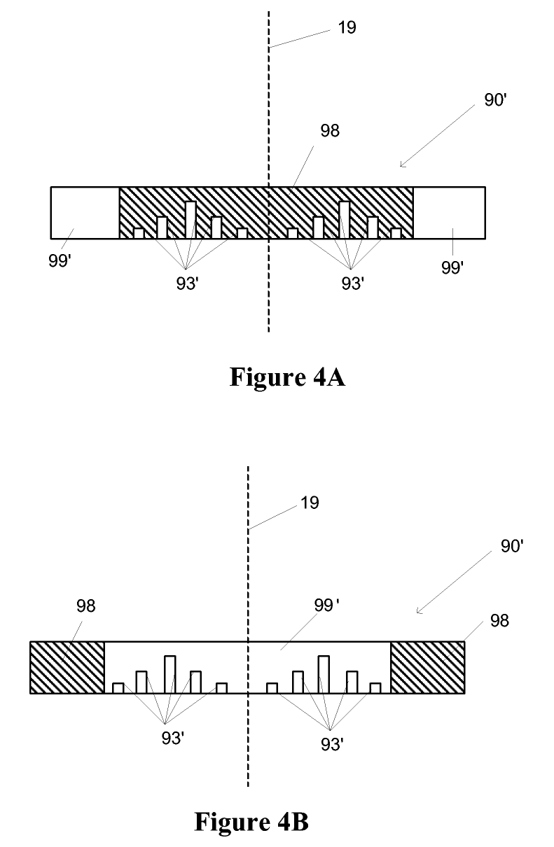

FIGS. 4A and 4B illustrate schematic radial cross sectional views of a switchable optical element for use in an objective lens system in accordance with a further embodiment of the present invention.

Using a lens having a relatively low free working distance is desirable, as it allows the optical scanning head of the device to be relatively compact. However, the present inventors have realised that having an objective lens system using a relatively low free working distance can be problematic, if the optical scanning device is arranged to scan different types of optical record carrier.

For example, FIGS. 1A and 1B illustrate an objective lens system comprising a first lens 102 and a second lens 103, spaced apart along an optical axis 104. FIG. 1A shows the objective lens system 102, 103 being utilised to scan a first type of optical record carrier 101 of cover layer thickness T1, using a first radiation beam 105. FIG. 1B shows the same objective lens system 102, 103 being used to scan a second type of record carrier 101′ of cover layer thickness T2, using a second, different wavelength of radiation 105′. It can be seen that the first optical record carrier 101 has a smaller cover layer thickness than the second optical record carrier 101′. The free working distance F1 between the objective lens system and the adjacent outer (entrance) surface of the optical record carrier 101, is thus much greater than the corresponding free working distance F2 in relation to the second optical record carrier 101′.

It can thus be seen that, as the cover layer thickness of the record carrier increases, there is typically a corresponding decrease in the free working distance. This is undesirable, as it can lead to instances in which the surface of the optical record carrier contacts the objective lens, potentially leading to damage of either the lens or the surface, particularly if the optical scanning device is knocked.

The present inventors have realised that this problem may be overcome by inserting a chamber containing a fluid between the two fixed lens elements of the objective lens. The fluid is displaceable, such that in one configuration the fluid occupies an optically active portion of the chamber, and in the other configuration the fluid does not occupy the optically active portion of the chamber. The optically active portion of the chamber is that volume of the chamber through which the radiation beam (used for scanning the information layer of the respective optical record carrier) passes. The fluid may be any material that flows e.g. liquid, gas or liquid crystal.

The chamber and associated fluid thus act to provide a variable refractive element i.e. a refractive element, the performance of which varies depending upon whether the first fluid occupies the optically active portion of the chamber or not. By moving the fluid between the two positions, the focal lens of the objective lens element can easily be altered, so as to ensure that the free working distance, between the objective lens system and the entrance surface of the disc being scanned, is appropriate for the particular record carrier being scanned. This decreases the likelihood of the lens contacting the surface of the scanned disc, and thus also the likelihood of damage to the disc or the lens.

The objective lens system is configured to satisfy the equation: Focal2−Focal1>0.9 (T2−T1)/N,

where T1 is the first cover layer thickness, T2 is the second cover layer thickness, T2>T1, N is the refractive index of the second cover layer, Focal1 is the first focal length, and Focal2 is the second focal length of the lens system. This condition can hold true for all situations, even where F2 is greater than F1 i.e. the free working distance between the lens and the second optical carrier is greater than the free working distance between the lens and the first optical record carrier (in spite of the fact that the second optical record carrier has a greater cover layer thickness).

This condition still holds true, even when the objective lens system is being operated in the near field e.g. with a free working distance of the order of one wavelength of the scanning radiation beam. For instance, the free working distance may be as small as a quarter of the wavelength (λ) of the scanning radiation beam i.e. the minimum free working distance is λ/4.

The variable refractive index element, including the chamber and the associated fluid, can be formed utilising a system incorporating a first fluid and a second fluid having different refractive indices. A pumping system can be used to move a first fluid to occupy the optically active portion of the chamber, and to not occupy the optically active portion of the chamber (i.e. when the second fluid occupies the optically active portion of the chamber). Suitable pumping systems are, for example, illustrated in US 2003/006140 & PCT Application WO 2004/027490. In US 2003/006140 the two fluids have dissimilar dielectric constants, with dielectric pumping and variable dielectric pumping being used to move fluids along channels. By appropriately coupling one or more channels to the chamber, the position of a first fluid in the chamber may be adjusted.

In WO 2004/027490, a switchable optical element is described, incorporating a first fluid that is electrically conductive, and a second fluid that is electrically insulative. A conduit, having two ends, is provided, with each end being fluidly connected to the chamber at a separate location. The position of a first fluid within the chamber is altered by the application of electrowetting forces.

However, using such circulation systems have disadvantages. Such circulation systems are relatively complex, and require additional space.

Preferred embodiments, as described below with reference to FIGS. 3A, 3B, 4A and 4B, utilise a single chamber, with no additional conduits. The first fluid takes the form of a liquid within the chamber. The remainder of the chamber may be at substantially vacuum, or may be filled with a second fluid (e.g. liquid), having a different refractive index to the first liquid. Preferably, the second fluid is an insulator (i.e. insulative) or non-polar. In practice, it will be appreciated that any liquidless portions of the chamber that are normally at substantially vacuum will in fact contain vapour of the first liquid.

The first fluid is electrically susceptible i.e. it is a fluid that reacts to an electric field. For instance, it may be a conductive or polar liquid. Consequently, by appropriate application of voltages, the liquid may be moved between a first position in which it occupies the optically active portion of the chamber, and a second position in which it does not occupy the optically active portion of the chamber. It is preferable if the remainder of the chamber is either substantially a vacuum or filled with a gas—the difference in refractive index between a liquid and a gas (or vacuum), is generally much larger than the difference in refractive indices between two liquids.

A suitable optical scanning device will now be described in more detail, and then subsequently further details of the objective lens system of preferred embodiments then described.

FIG. 2 shows a device 1 for scanning a first information layer 2 of a first optical record carrier 3 by means of a first radiation beam 4, the device including an objective lens system 8.

The optical record carrier 3 comprises a transparent layer 5, on one side of which information layer 2 is arranged. The side of the information layer 2 facing away from the transparent layer 5 is protected from environmental influences by a protective layer 6. The side of the transparent layer facing the device is called the entrance face. The transparent layer 5 acts as a substrate for the optical record carrier 3 by providing mechanical support for the information layer 2. Alternatively, the transparent layer 5 may have the sole function of protecting the information layer, while the mechanical support is provided by a layer on the other side of the information layer 2, for instance by the protective layer 6 or by an additional information layer and transparent layer connected to the uppermost information layer. It is noted that the information layer has first information layer depth 27 that corresponds, in this embodiment as shown in FIG. 2, to the thickness of the transparent layer 5. The information layer 2 is a surface of the carrier 3.

Information is stored on the information layer 2 of the record carrier in the form of optically detectable marks arranged in substantially parallel, concentric or spiral tracks, not indicated in the figure. A track is a path that may be followed by the spot of a focused radiation beam. The marks may be in any optically readable form, e.g. in the form of pits, or areas with a reflection coefficient, or a direction of magnetisation different from the surroundings, or a combination of these forms. In the case where the optical record carrier 3 has the shape of a disc.

As shown in FIG. 2, the optical scanning device 1 includes a radiation source 7, a collimator lens 18, a beam splitter 9, an objective lens system 8 having an optical axis 19, and a detection system 10. Furthermore, the optical scanning device 1 includes a servo circuit 11, a focus actuator 12, a radial actuator 13, and an information processing unit 14 for error correction.

In this particular embodiment, the radiation source 7 is arranged for consecutively or simultaneously supplying a first radiation beam 4, a second radiation beam 4′ and a third radiation beam 4″. For example, the radiation source 7 may comprise a tunable semiconductor laser for consecutively supplying the radiation beams 4, 4′ and 4″, or three semiconductor lasers for separately supplying these radiation beams.

The radiation beam 4 has a wavelength λ₁ and a polarisation p₁, the radiation beam 4′ has a wavelength λ₂ and a polarisation p₂, and the radiation beam 4″ has a wavelength λ₃ and a polarisation p₃. The wavelengths λ₁, λ₂, and λ₃ are all different. Preferably, the difference between any two wavelengths is equal to, or higher than, 20 nm, and more preferably 50 nm. Two or more of the polarisations p₁, p₂, and p₃ may differ from each other.

The collimator lens 18 is arranged on the optical axis 19 for transforming the radiation beam 4 into a substantially collimated beam 20. Similarly, it transforms the radiation beams 4′ and 4″ into two respective substantially collimated beams 20′ and 20″ (not shown in FIG. 1).

The beam splitter 9 is arranged for transmitting the radiation beams towards the objective lens system 8. Preferably, the beam splitter 9 is formed with a plane parallel plate that is tilted at an angle α with respect to the optical axis, and more preferably α=45°.

The objective lens system 8 is arranged for transforming the collimated radiation beam 20 to a first focused radiation beam 15 so as to form a first scanning spot 16 in the position of the information layer 2.

During scanning, the record carrier 3 rotates on a spindle (not shown in FIG. 1), and the information layer 2 is then scanned through the transparent layer 5. The focused radiation beam 15 reflects on the information layer 2, thereby forming a reflected beam 21 which returns on the optical path of the forward converging beam 15. The objective lens system 8 transforms the reflected radiation beam 21 to a reflected collimated radiation beam 22. The beam splitter 9 separates the forward radiation beam 20 from the reflected radiation beam 22 by transmitting at least part of the reflected radiation 22 towards detection system 10. In the particular embodiment shown, the beam splitter 9 is a polarising beams splitter. A quarter waveplate 9′ is positioned along the optical axis 19 between the beam splitter 9 and the objective lens system 8. The combination of the quarter waveplate 9′ and the polarising beam splitter 9 ensures that the majority of the reflected radiation beam 22 is transmitted towards the detection system 10.

The detection system 10 includes a convergent lens and a quadrant detector, which are arranged for capturing said part of the reflected radiation beam 22 and converting it to one or more electrical signals.

One of the signals is an information signal, the value of which represents the information scanned on the information layer 2. The information signal is processed by the information processing unit 14 for error correction.

Other signals from the detection system 10 are a focus error signal and a radial tracking error signal. The focus error signal represents the axial difference in height along the Z-axis between the scanning spot 16 and the position of the information layer 2. Preferably, this signal is formed by the “astigmatic method” which is known from, inter alia, the book by G. Bouwhuis, J. Braat, A. Huijiser et al, “Principles of Optical Disc Systems”, pp. 75-80 (Adam Hilger 1985, ISBN 0-85274-785-3). The radial tracking error signal represents the distance in the XY-plane of the information layer 2 between the scanning spot 16 and the centre of track in the information layer 2 to be followed by the scanning spot 16. This signal can be formed from the “radial push-pull method” which is also known from the aforesaid book by G. Bouwhuis, pp. 70-73.

The servo circuit 11 is arranged for, in response to the focus and radial tracking error signals, providing servo control signals for controlling the focus actuator 12 and the radial actuator 13 respectively. The focus actuator 12 controls the position of the objective lens 8 along the Z-axis, thereby controlling the position of the scanning spot 16 such that it coincides substantially with the plane of the information layer 2. The radial actuator 13 controls the radial position of the scanning spot 16 so that it coincides substantially with the centre line of the track to be followed in the information layer 2 by altering the position of the objective lens 8.

The objective lens 8 is arranged for transforming the collimated radiation beam 20 to the focus radiation beam 15, having a first numerical aperture NA₁, so as to form the scanning spot 16. In other words, the optical scanning device 1 is capable of scanning the first information layer 2 by means of the radiation beam 15 having the wavelength λ₁, the polarisation p₁ and the numerical aperture NA₁.

Furthermore, although not shown, the optical scanning device in this embodiment is also capable of scanning a second information layer 2′ of a second optical record carrier 3′ by means of the radiation beam 4′, and a third information layer 2″ of a third optical record carrier 3″ by means of the radiation beam 4″. Thus, the objective lens system 8 transforms the collimated radiation beam 20′ to a second focused radiation beam 15′, having a second numerical aperture NA₂ so as to form a second scanning spot 16′ in the position of the information layer 2′. The objective lens 8 also transforms the collimated radiation beam 20″ to a third focused radiation beam 15″, having a third numerical aperture NA₃ so as to form a third scanning spot 16″ in the position of the information layer 2″.

Any one or more of the scanning spots 16, 16′, 16″ may be formed with two additional spots for use in providing an error signal. These associated additional spots can be formed by proving an appropriate diffractive element in the path of the optical beam 20.

Similarly to the optical record carrier 3, the optical record carrier 3′ includes a second transparent layer 5′ on one side of which the information layer 2′ is arranged with the second information layer depth 27′, and the optical record carrier 3″ includes a third transparent layer 5″ on one side of which the information layer 2″ is arranged with the third information layer depth 27″.

In this embodiment, the optical record carrier 3, 3′ and 3″ are, by way of example only, a “Blu-ray Disc”-format disc, a “Red-DVD”-format disc and a CD-format disc, respectively. Thus, the wavelength λ₁ is comprised in the range between 365 and 445 nm, and preferably, is 405 nm. The numerical aperture NA₁ equals about 0.85 in both the reading mode and the writing mode. The wavelength λ₂ is comprised in the range between 620 and 700 nm, and preferably, is 650 nm. The numerical aperture NA₂ equals about 0.6 in the reading mode and is above 0.6, preferably 0.65, in the writing mode. The wavelength λ₃ is comprised in the range between 740 and 820 nm and, preferably is about 785 nm. The numerical aperture NA₃ is below 0.5, preferably 0.45.

FIGS. 3A and 3B show a cross-section of an embodiment of an optical lens system 8. The lens system 8 is composed of two solid lens elements 82 and 84, which are cemented together at their border portion 86. The lens elements are made of glass or transparent plastic. A liquid chamber 90 is located on the optical axis 19, between the lens elements 82, 84. In this embodiment, both of the inner walls of the chamber 90 crossing the optical axis are refractive surfaces. In particular, the first of the inner walls is defined by the refractive surface 92 of lens element 82, and a second inner surface by the refractive surface 94 of lens element 84. The common inner wall 96 of the lens elements, in conjunction with the surfaces 92, 94, defines the volume of the chamber.

The chamber 90 is partially filled with an electrically conductive or polar liquid 98, for example salted water, hereinafter also termed a first liquid or first fluid. The remaining space 99 in the chamber 90 may be filled with another, non-conducting fluid, such as liquid e.g. oil, or a gas. Alternatively, the remaining space 99 of the chamber may be at vacuum, which in practice will mean that it comprises vapour of the first liquid 98. Such a remaining volume of the chamber (e.g. the second medium or vacuum) has an index of refraction different from the index of refraction of the polar liquid 98.

First electrodes 91, 93 are arranged adjacent the central portion of the refractive surfaces 92 and 94 (i.e. the portion crossing the optical axis). These electrodes 91, 93 define the optically active portion of the lens system 8 i.e. the portion that passes an incident radiation beam 20, 20′, the wavefront of which is modified by the lens system 8. The first pair of electrodes 91, 93 are made of an electrically conductive, optically transparent material, for example ITO (indium tin oxide). The electrodes are optically transparent at the wavelengths of the beams 20, 20′ used for scanning the relevant optical record carriers 3, 3′.

A second electrode means 95 is arranged at the edge portions of the chamber, distant from the optical axis 19, i.e. the portion outside the optically active portion. The ends of this electrode means 95 is separated from the ends of the first electrodes 91, 93 by a gap 78. The electrode means 95 need not be transparent, and can be made of a metallic material. As the lens system 8 is generally circularly symmetric about the optical axis 19, it will be appreciated that the gaps 78 will typically be annular. A third electrode 97 is in electrical contact with the polar liquid 98. The electrode 97 may be in direct electrical contact with the polar liquid 98. Alternatively, electrode 97 may be insulated, and capacitively coupled to liquid 98. This electrode 97 is permanently connected to a first output 52 of a voltage source 50. The second output 54 of this source 50 can be connected to either the first electrodes 91, 93, or the second electrode means 95, via the switch 60.

The inner side of the electrodes, i.e. the side facing the liquid chamber 90, is covered with a transparent electrically insulating layer formed, for example, of parylene. The inner side of this layer and the gaps 78 between the ends of the first electrodes 91, 93 and the ends of the second electrode 95, is coated with a hydrophobic layer. This layer is transparent, and may be formed of Teflon™ AF 1600 produced by DuPont™. Alternatively, a single layer, which is both insulating and hydrophobic, may be utilised.

The first electrodes 91, 93, the second electrode means 95 and the third electrode 97 together form a configuration of electrowetting electrodes which together with the voltage control system 50, 52, 54, 60 form a fluid system switch. This fluid system switch acts upon the chamber 90 containing the polar fluid 98, in order to switch between a first discrete state (or configuration) in which the fluid occupies the optically active portion (as shown in FIG. 3A), and a second discrete state in which the first fluid 98 does not occupy the optically active portion (FIG. 3B).

In the first discrete configuration of the lens system, shown in FIG. 3A, the switch 60 connects the second output 54 of the voltage source 50 to the power of first electrodes 91, 93, so as the voltage V of an appropriate value is applied across each of the first electrodes 91, 93 and the common, third electrode 97. The applied voltage V provides an electrowetting force such that the switchable unit adopts the first state. As a result of the applied voltage V, the hydrophobic layer overlying the first electrodes 91, 93 becomes at least relatively hydrophilic in nature, thus aiding the preference of the polar liquid 98 to fill the chamber space between the first electrodes, i.e. the optically active portion. If a second medium was previously located within the optically active portion, then the polar liquid 98 will displace this second medium.

In the second discrete state shown in FIG. 3B, the first liquid 98 fills the chamber space adjacent the second electrode means, as a result of electrowetting forces provided by the voltage applied to this electrode means 95. The lens 8 may be switched between the states by operation of the switch 60. In the second state, due to the voltage applied between electrodes 97 and 95, the hydrophobic layer overlying electrode 95 is now at least relatively hydrophilic, and tends to attract the first polar liquid 98. In this configuration, the liquid 98 is not located within the optically active portion of the lens system 8.

Movement of the polar liquid in and out of the optically active portion of the lens system 8, means that the refractive index in the space between the two refractive surfaces 92 and 94 is switched between two values. Since this refractive index, together with the curvatures of the refractive surfaces, determine the optical power of the lens system 8 (as provided by fixed lens elements 82, 84 and chamber 90), the optical power of this lens can thus be switched between two discrete values i.e. the lens 8 can be switched between two different focal lengths.

In the first configuration shown in FIG. 3A the objective lens system 8 is arranged to scan the information layer 2 of a first optical record carrier 3 using a first radiation beam 20, 15. The first optical record carrier has a cover layer 5 of thickness 27. The optical lens system 8 is configured such that the focal length of the lens system 8 when in the first configuration is arranged to focus the radiation beam 20 on the information layer 2, resulting in a free working distance F3 between the lens system 8 and the entrance surface of the optical record carrier 3.

In the second configuration shown at FIG. 3B, the lens system 8 is being utilised to scan the information layer 2′ of a second optical record carrier 3′ using a second radiation beam 20′, 15′. The second optical record carrier 3′ has a transparent layer 5′ of thickness 27′. It will be observed that the thickness of the second cover layer is different from the thickness of the first cover layer. The focal length of the lens system 8 in the second configuration is selected to provide a free working distance F4 between the lens system 8 and the entrance surface of the second optical record carrier 3′.

The focal lengths of the lens system in both configurations is selected such that a minimum free working distance is maintained between the lens system 8 and the optical record carrier being scanned. This free working distance is typically greater than 50 μm, more preferably greater than 100 μm and even more preferably greater than 150 μm.

Preferably, the amount of the first liquid 98 and the volume of the chamber 90 are selected such that the liquid 98 will always be in contact with both the first electrodes 91, 93 and the second electrodes 95. For instance, when in the first configuration shown in FIG. 3A preferably the outermost portion of the liquid 98 will lie adjacent the edge of the second electrode 95. Correspondingly, when in the second configuration shown in FIG. 3B, the innermost portion of the fluid (i.e. the portion of the fluid closest to the optical axis 90) will lie adjacent to the surface of at least one of the electrodes 91, 93. In this way, during each transition between the first and second configurations of the lens system 8, the polar liquid 98 will always be under the influence of the electrowetting force of a newly activated electrode. This will facilitate movement of the liquid between the two states.

To further facilitate switching between the two states, the first electrodes 91 and 93 may not be activated (or deactivated) simultaneously, but one of the electrodes 91, 93 may have a voltage applied (or removed) a predetermined time period after the voltage has been applied (or removed) from the other electrode 93, 91.

It will be appreciated that the above arrangement of electrodes is provided by way of example only. Various other configurations of electrodes, suitable for movement of the fluid within the chamber, can be utilised. For instance, electrode 91 could be split into a plurality of discrete rings. Each ring could be separately controllable i.e. the voltage applied to each ring could be separately controlled, so as to facilitate movement of the fluid. In such an instance, electrode 97 could be omitted, as the function provided by that electrode (i.e. providing a potential difference across a portion of the fluid), can be provided by the rings.

One or more refractive surfaces of the lens system may be aspherical. An aspherical surface allows the correction of spherical aberration introduced by a lens surface having spherical surfaces, so that no additional lens elements are needed for such correction. In the lens system illustrated in FIGS. 3A and 3B, one or both of the inner lens surfaces 92, 94 and/or one or both of the outer lens surfaces 83, 85, may be aspherical. The specific design of the lens system 8 determines which and how many refractive surfaces of that system should be aspherical.

Such a lens system 8 can be used to provide compatibility between different types (formats) of optical record carrier. For instance, the lens system 8 may be arranged in a first configuration to provide a relatively short focal length for scanning of Blu-Ray discs, and a second, longer focal length for scanning of DVDs. The entrance pupil diameter of the objective lens is typically selected so as to provide the numerical aperture required for Blu-Ray disc scanning. The increase in focal length will be accompanied by a corresponding reduction in numerical aperture. Preferably, the lens configuration is designed such that the increase in focal length leads to the a predetermined change in numerical aperture, so as to provide the NA required for DVD scanning, for the same entrance pupil diameter required for Blu-Ray discs. Hence, no additional entrance pupil reducing means is required within the system when swapping between Blu-Ray discs and DVD modes.

It will be appreciated that different configurations of the lens system may be utilised, with different fluids and shaped surfaces. In one particular embodiment, the lens system is based on two elements made of PMMA (polymethylmethacrylate). The first fluid is water i.e. a polar liquid and the second fluid is air. The objective lens of FIG. 3 will now be described in more detail. The free working distance for the Blu-Ray disc in this embodiment is 0.1 mm and for the DVD scanning mode 0.325 mm. The entrance pupil diameter for the objective lens system 8 for both Blu-Ray discs and DVD scanning modes is 3.0 mm, while the corresponding numerical apertures are 0.85 for Blu-Ray disc and 0.6 for DVD. Furthermore, the wavelength used for Blu-ray disc is 405 nm and for DVD 650 nm. When reading out the Blu-Ray disc the second fluid is along the optical axis while when reading out the DVD disc the firstfluid is along the optical axis. Lens element 82 is a bi-aspheric lens. Lens element 82 is made of PMMA having a refractive index of 1.506 at wavelength 405 nm and 1.489 at 650 nm. The thickness of lens element 82 along the optical axis is 1.7 mm. The rotational symmetric shape of the lens surface facing the radiation source is given by

$$z ( r ) = {\sum }_{i = 1}^{8} {B}_{2 i} {r}^{2 i} \qquad ( 1 )$$

where z is the position of the surface in the direction of the optical axis in millimetres, r the distance from the optical axis in millimetres, and Bₖ the coeficient of the k-th power of r.

In this embodiment the coefficients B₂ to B₁₆ are 0.22479804, 0.011737518, −0.0011272775, −0.0043806488, 0.0030649439, 0.00071979291, −0.00098418213 and 0.00019606689, respectively. The aspherical shape of the surface facing (adjacent) the disc is also given by formula (1), with the coefficients B₂ to B₁₆ in this embodiment being 0.021586261, 0.016776859, 0.0060300899, −0.10186709, 0.18624983, −0.1429133, 0.049056447 and −0.0058902642, respectively. The thickness of the chamber along the optical axis between the two lens elements 82 and 84 is 1.714 mm.

The second lens element 84 is bi-aspherical. Lens element 84 is made of PMMA. Lens element 84 has a thickness along the optical axis of 0.8 mm. The aspherical shape of the surface facing the radiation source is given by formula (1) with the coefficients B₂ to B₁₆ given by 0.86386843, 0.60648623, −1.5327551, 38.214572, −343.49687, 1668.8654, −4046.122 and 3826.0365, respectively. The aspherical shape of the surface facing the disc is given by formula (1), with the coefficients B₂ to B₁₆ in this embodiment being −0.23078012, 1.7523731, −20.860817, 190.89565, −1049.4858, 2991.2125, −3329.9621 and 0, respectively. The cover layer of the disc is made of polycarbonate, having refractive index of 1.622 at wavelength of 405 nm and 1.580 at 650 nm. The cover layer thickness is 0.1 mm for Blu-ray disc and 0.6 mm thickness for DVD.

In this embodiment the focal length in the first configuration is Focal1=1.767 mm while the cover layer thickness is T1=0.1 mm. In the second configuration, the focal length Focal2=2.445 mm, T2=0.6 mm and the refractive index of the cover layer is N=1.580. As a result the requirement (Focal2−Focal1)>(T2−T1)/N is fulfilled.

In the above embodiment, the interfaces of the optically active portion between the chamber and the adjacent lenses have been described as refractive surfaces. However, it will be appreciated that one or more of these surfaces may not be refractive, or may not only be refractive. For instance, one or more of the surfaces may be diffractive. For instance, one shaped may be shaped so as to provide a first diffractive grating structure.

FIGS. 4A and 4B show a chamber 90′, as used in an alternative objective lens system in accordance with an embodiment of the present invention. As in the embodiment described with reference to FIGS. 3A and 3B, the chamber 90′ includes a first polar liquid 98. This polar liquid 98 is switchable between a first configuration (shown in FIG. 4A) in which the liquid 98 occupies the optically active portion of the chamber, and a second configuration in which the liquid 98 does not occupy the optically active portion of the chamber. This switching is, as described with reference to FIGS. 3A and 3B, provided by an electrowetting electrode system.

In this particular embodiment, one of the surfaces defining the chamber, within the optically active portion of the chamber, provides a diffractive grating structure. The diffractive grating structure may have the same refractive index as the polar liquid 98, or it may have the same refractive index as the second medium 99′, or may have a refractive index different from both the polar liquid 98 and the second medium 99′.

FIGS. 4A and 4B show radial cross-sections of this embodiment, with the chamber and diffractive grating structure 93′ being circularly symmetric about the optical axis 19. In other words, the diffractive grating structure is provided by a series of rings, concentric with the optical axis 19. The diffractive grating structure defined by the rings may be used to alter the phase of the wavefront of one or more of the incident radiation beams.

For instance, an objective lens system 8 incorporating a chamber 90′ between the two fixed objective lens elements 82, 84, could be utilised within an optical scanning device for scanning three different types of optical record carrier, each being scanned with a different wavelength of radiation.

For example, the step heights of the diffraction grating (i.e. the length of the diffraction steps along the optical axis) may be selected to introduce a phase change that is an integral multiple of 2π for two of the wavelengths. The wavelength of the respective radiation beam traversing the chamber will be dependent upon the refractive index of the medium (or vapour of the first fluid) within the optically active portion of the chamber. As the medium within this optically active portion may be varied, depending upon whether the optical length system is in a first configuration or a second configuration (i.e. the position of the first fluid), various permutations of this step height are possible.

For instance, the step height may be varied such that the diffractive grating structure is an integral multiple of 2π for a first wavelength when the chamber 90′ is in a first configuration, and is an integral multiple of 2π for a second, different wavelength when the chamber 90′ is in a different configuration.

Alternatively, the step heights may be selected to introduce a phase change that is an integral multiple of 2π for two different wavelengths when the chamber 90′ is in one (i.e. the first or second) configuration.

An example of the implementation of this system, for use in a system using three beams, each for scanning a different type of optical record carrier, will now be briefly described. In a first configuration (shown in FIG. 4A), the diffractive grating structure is invisible (i.e. it is arranged to introduces a phase change that is an integral multiple of 2π of the wavelength of the radiation beam) for a first radiation beam. The first type of optical record carrier is scanned by the first radiation beam, with the focal length of the lens system 8 being provided only by the refractive surfaces of the lens.

The second configuration is utilised for scanning optical record carriers of second and third types. In the second configuration (shown in FIG. 4B), the diffractive grating structure is invisible to the second radiation beam (i.e. it is arranged to introduces a phase change that is an integral multiple of 2π of the wavelength of the radiation beam). Thus, the focal length of the objective lens is again only determined by the refractive surfaces. The focal length of this second configuration will of course be different to that of the first configuration, due to the polar fluid 98 being located in a different position.

The third type of optical record carrier is scanned using a third wavelength of radiation beam. The diffractive grating structure will thus introduce a phase change in the wavefront of the third radiation beam. Thus, the focal length of the objective lens system 8 will be defined not only by the relevant refractive surfaces, but also by the diffractive phase structure. Thus, the objective lens system may be utilised to provide three different focal lengths for three different wavelengths of radiation. Each focal length is arranged to ensure a suitable free working distance between the objective lens system and the disc being scanned.

Preferably, the diffractive phase structure is also utilised to provide spherical aberration, to compensate for the spherical aberration arising from the cover layer thickness. As described above, one or more refractive surfaces of the lens system may be aspherical. The diffractive grating structure will be arranged to provide spherical aberration to the third radiation beam, such that the total spherical aberration provided by the diffractive grating structure and the refractive surface(s) is suitable for compensating for the spherical aberration arising for the particular thickness of the layer of the third type of optical record carrier, when the objective lens system is in the appropriate configuration for scanning that record carrier.

It will be appreciated that the above is described by way of example only, and that various other implementations are possible. For instance, both of the opposite surfaces of the chamber within the optically active portion may be diffractive, each incorporating one or more different diffractive gratings.

As described above, by providing an objective lens systems, the focal length of which is varied in dependence on the optical record carrier being scanned, to provide a minimum predetermined free working distance, the likelihood of damage to lens or record carrier is decreased.

1. An optical scanning device (1) for scanning an information layer (2) of a first optical record carrier (3) having a first cover layer thickness (27) and an information layer (2′) of a second optical record (3′) carrier having a second, different cover layer thickness (27′);
the device comprising an objective lens system (8) for converging a radiation beam (20) on said information layers (2, 2′), the objective lens system (8) comprising a first lens element (82) and a second lens element (84) spaced apart along an optical axis (19);
the objective lens system (8) further comprising a switchable optical element comprising a first fluid (98), and a chamber (90;90′) positioned between said first lens (82) and said second lens (84);
wherein the objective lens system (8) is switchable between a first configuration in which the first fluid (98) occupies an optically active portion of the chamber (90;90′) and a second configuration in which the first fluid (98) does not occupy the optically active portion of the chamber (90;90′), such that in one of said configurations the objective lens system (8) has a first focal length for scanning the information layer (2) of the first optical record carrier (3), and in the other configuration the objective lens system (8) has a second, different focal length for scanning the information layer (2′) of the second optical record carrier (3′), and
the objective lens system is arranged to satisfy the condition:
Focal2−Focal1>0.9(T2−T1)/N,
where T1 is the first cover layer thickness, T2 is the second cover layer thickness, T2>T1, N is the refractive index of the second cover layer, Focal1 is the first focal length, and Focal2 is the second focal length.

2. An optical scanning device (1) as claimed in claim 1, wherein the objective lens system is arranged to satisfy the condition:
F2>F1
where F2 is the free working distance between the objective lens system (8) in the second configuration and the second optical carrier (3′), and F1 is the free working distance between the objective lens system (8) of the first configuration and the first optical record carrier (3).

3. An optical scanning device as claimed in claim 1, wherein at least one of said focal lengths is of sufficient magnitude to ensure that the free working distance between the objective lens system (8) and the optical record carrier (3, 3′) being scanned is greater than a predetermined minimum.

4. An optical scanning device as claimed in claim 3, wherein each of said focal lengths is of sufficient magnitude to ensure that free working distance between the objective lens system (8) and the optical record carrier (3, 3′) being scanned is greater than a predetermined minimum.

5. An optical scanning device as claimed in claim 3, wherein said minimum free working distance is 50 μm.

6. An optical scanning device as claimed in claim 1, wherein the first fluid (98) is an electrically susceptible fluid, the chamber (90) being provided with an electrode configuration (91, 93, 95), wherein application of a voltage, from a voltage control system (50), to electrodes causes movement of the fluid (98), and
wherein the electrode configuration comprises at least one first, central, electrode (91,93) adjacent to the inner walls of the chamber (90) at the position of the optically active portion, at least one second electrode (95) adjacent to the inner walls of the chamber (90) at positions outside the optically active portion, and a third electrode (97) in contact with the electrically susceptible fluid (98) such that the optical element will be in the first configuration when a voltage is applied between said first electrode (91, 93) and the third electrode (97), and in the second configuration when a voltage is applied between said second electrode (95) and the third electrode (97).

7. An optical scanning device as claimed in claim 6, wherein the interior wall of the chamber (90;90′) is coated with an insulating hydrophobic layer.

8. An optical scanning device as claimed in claim 1, wherein the chamber (90;90′) further comprises one of a vapour of the first fluid (98), and a second fluid (99′) having an index of refraction different from that of the first fluid (98).

9. An optical scanning device as claimed in claim 1, wherein at least one chamber wall situated in the optically active portion forms a refractive lens surface (92, 94).

10. An optical scanning device as claimed in claim 1, wherein at least one chamber surface situated in the optically active portion forms a diffractive grating structure (93′).

11. An optical scanning device as claimed in claim 10, for scanning the first information layer (2) by means of a first radiation beam having a first wavelength, the second information layer (2′) by means of a second radiation beam having a second wavelength, and a third information layer of a third optical record carrier by means of a third radiation beam having a third wavelength, wherein said first, second and third wavelengths differ from each other, and
wherein the diffractive grating structure (93′) comprises a series of steps of predetermined height to introduce a phase change that is in integral multiple of 2π for at least one of said wavelengths in at least one of said configurations.

12. An optical scanning device as claimed in claim 1, wherein the change in focal length between the first configuration and the second configuration provides the required change in numerical aperture for scanning the respective optical record carrier (3, 3′).

13. An objective lens system (8) for an optical scanning device (1), the optical scanning device being arranged to scan an information layer (2) of a first optical record carrier (3) having a first cover layer thickness (27) and an information layer (2′) of a second optical record carrier (3′) having a second, different cover layer thickness (27′), the objective lens system (8) being suitable for converging a radiation beam on said information layers (2, 2′), the objective lens system (8) comprising a first lens (82) and a second lens (84) spaced apart along an optical axis (19);
the objective lens system further comprising a switchable optical element comprising a first fluid (98), and a chamber (90;90′) positioned between said first lens (82) and said second lens (84);
wherein the objective lens system (8) is switchable between a first configuration in which the first fluid (98) occupies an optically active portion of the chamber and a second configuration in which the first fluid (98) does not occupy the optically active portion of the chamber, such that in one of said configurations the objective lens system (8) has a first focal length for scanning the information layer (2) of the first optical record carrier (3), and in the other configuration the objective lens system (8) has a second, different focal length for scanning the information layer (2′) of the second optical record carrier (3′), and
the objective lens system is arranged to satisfy the condition: Focal2−Focal1>0.9 (T2−T1)/N,
where T1 is the first cover layer thickness, T2 is the second cover layer thickness, T2>T1, N is the refractive index of the second cover layer, Focal1 is the first focal length, and Focal2 is the second focal length.

14. A method of manufacturing an optical scanning device (1) for scanning an information layer (2) of a first optical record carrier (3) having a first cover layer thickness (27) and an information layer (2′) of a second optical record carrier (3′) having a second, different cover layer thickness (27′);
the method comprising: providing an objective lens system (8) for converging a radiation beam on said information layers (2, 2′), the objective lens system comprising a first lens element (82) and a second lens element (84) spaced apart along an optical axis (19);
the objective lens system further comprising a switchable optical element comprising a first fluid (98), and a chamber (90;90′) positioned between said first lens and said second lens;
wherein the objective lens system (8) is switchable between a first configuration in which the first fluid (98) occupies an optically active portion of the chamber (90;90′) and a second configuration in which the first fluid does not occupy the optically active portion of the chamber (90;90′), such that in one of said configurations the objective lens system (8) has a first focal length for scanning the information layer (2) of the first optical record carrier (3), and in the other configuration the objective lens system (8) has a second, different focal length for scanning the information layer (2′) of the second optical record carrier (3′), and
the objective lens system is arranged to satisfy the condition: Focal2−Focal1>0.9 (T2−T1)/N,
where T1 is the first cover layer thickness, T2 is the second cover layer thickness, T2>T1, N is the refractive index of the second cover layer, Focal1 is the first focal length, and Focal2 is the second focal length.
